(19) United States
(12) Patent Application Publication
(10) Pub. No.: US 2004/0185221 A1
(43) Pub. Date: Sep. 23, 2004

(54) Multi-color mats and apparatus

(76) Inventors: Roy L. Hood, St. Peters, MO (US); Gary L. Noedel, Chesterfield, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/814,679

(22) Filed: Mar. 31, 2004

Related U.S. Application Data
(63) Continuation of application No. 09/634,381, filed on Aug. 9, 2000.
(60) Provisional application No. 60/152,323, filed on Sep. 4, 1999.

(51) Int. Cl. B29B 11/06; B29C 45/38; B29C 45/22; B29C 45/20; B29C 45/03; B29C 45/02; B29C 45/00; B29C 35/00; A23P 1/00; A47L 25/00; A47L 23/04; B43L 21/00; A47L 17/08; A47L 13/10; A47K 7/02; A47L 1/06; B29C 47/00; B29C 47/06; D01D 5/20; B32B 33/00; D03D 27/00; D05C 17/00; D04H 11/00; B32B 3/02

(52) U.S. Cl. 428/85; 428/92; 428/95; 15/215; 425/554; 425/588; 264/167; 264/173.16; 264/173.18

(57) ABSTRACT

A rotary-molded, three-dimensional, multi-polymer article, e.g. a multi-color door mat, where sections of projecting elements comprise different polymers. Such multi-polymer articles are produced on a rotating cylindrical mold in continuous lengths wherein said apparatus comprises a rotatable, cylindrical mold having a plurality of circumferential, rows of cavities and a plurality of parallel grooves separating the rows of cavities. Two sources of polymer are fed to the rotating mold from a stationary polymer injection block in arcuate proximity to the mold and having a plurality of cavity injection ports for supplying at least two different polymers to corresponding rows of cavities to form projecting elements, and a plurality of base-forming injection ports for supplying polymer to corresponding parallel grooves to form a base.

This application claims the benefit of U.S. Provisional Application No. 60/152,323, filed Sep. 4, 1999.

### BACKGROUND OF THE INVENTION

Disclosed herein are three-dimensional, unitary, molded, multi-polymer articles with projecting elements extending from one side of a planar base and apparatus and methods for making such articles.

Doleman et al. disclosed in U.S. Pat. No. 3,507,010 apparatus and methods for making continuous, three-dimensional, molded, polymeric articles having blade-like elements projecting from one surface of a planar ribbed base. Such articles have been produced for a variety of applications, e.g. door mats, flooring surfaces, rain flaps and poultry nest pads. One limitation of the Doleman apparatus is that the projecting elements of the articles are made from a single polymeric material. An object of this invention is to produce articles with multi-polymer projecting elements. Surprisingly, it has been discovered that this can be achieved by the apparatus of this invention by first forming the base section of the projecting element and then injecting a different polymer to form the terminal portion of the projecting element through the base section. Another object of this invention is to provide multi-color mats where terminal portions of blade-like elements are of a different color than the base section of the blade-like elements and/or the base of the mat. These and other objects and advantages in molded articles and molding apparatus will be apparent from the following description of this invention.

### SUMMARY OF THE INVENTION

This invention provides three-dimensional, unitary, molded, multi-polymer articles comprising a generally planar two-dimensional base section and a plurality of projecting elements extending from one side of the base section, where at least some of the projecting elements are multi-polymer elements. A preferred embodiment of the article comprises a mat with multi-color blade-like projecting elements.

This invention also provides a polymer molding apparatus for making such multi-polymer articles. Such apparatus comprises a rotatable, cylindrical mold, e.g. having a plurality of circumferential, rows of cavities, and a plurality of parallel grooves separating said rows of cavities. The apparatus further comprises a stationary polymer injection block with a surface in arcuate proximity to said mold and having a plurality of cavity injection ports for supplying at least two polymers to cavities to form multi-polymer projecting elements. The polymer injection block will also comprise a plurality of surface injection ports, e.g. in a preferred embodiment for supplying polymer into the grooves to form the ribbed base of the article. More particularly, in the apparatus of this invention the stationary polymer injection block comprises two sets of circumferentially aligned, cavity injection ports for supplying at least two different polymers to at least a portion of said cavities.

This invention also comprises a method for forming multi-polymer, three-dimensional articles by first supplying a polymer from a first set of two sets of circumferentially aligned, cavity injection ports to a cavity area rotating into proximity with the first set of ports to form a base section-proximate part of the projecting elements; and, secondly, supplying a different polymer from a second set of said two sets of circumferentially aligned, cavity injection ports to the cavity area which has rotated past the first set of ports into proximity with the second set of ports to form terminal parts of projecting elements from the different polymer.

### BRIEF DESCRIPTION OF THE DRAWINGS

FIG. 1 illustrates a specific embodiment of the multi-color mat according to this invention wherein projecting elements contain a different colored pigment than the base section.

FIG. 2 illustrates another specific embodiment of the multi-color mat according to this invention wherein a portion of projecting elements contain the same pigment as the base section and a portion of the projecting elements contain a different color pigment from the base section.

FIGS. 3 and 4 illustrate the molding apparatus of the prior art.

FIG. 5 illustrates one embodiment of the polymer injection block of the present invention.

### DETAILED DESCRIPTION OF THE INVENTION

One aspect of this invention provides three-dimensional, unitary, molded, multi-polymeric articles comprising a generally planar two-dimensional base section formed from one polymer material and a plurality of projecting elements extending from one side of the base section, wherein at least some of the terminal parts of the projecting elements are formed from a second polymer material. In a preferred embodiment the base section of the article is formed from one polymer material, terminal parts of at least some of the projecting elements are formed from another polymeric material, and the base sections of projecting elements are formed from a mixture of the two polymeric materials. In many cases the base sections of the projecting elements will have one polymer material at its surface and another polymeric material at its core.

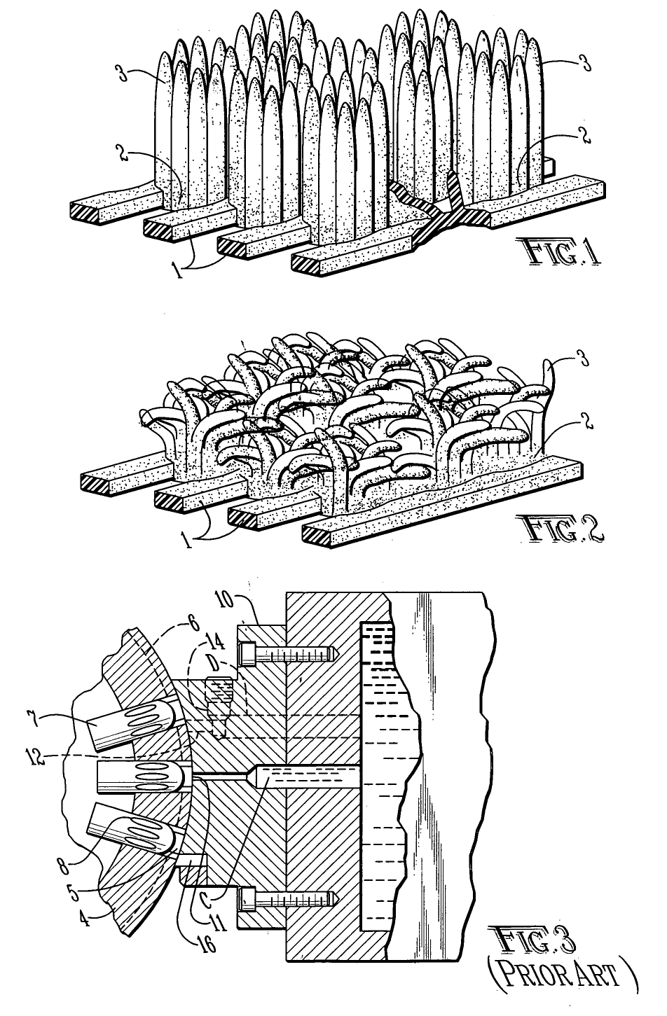

The distinct polymeric materials can differ in composition, e.g. comprise distinct polymers, or comprise the same base polymer with different additives, e.g. dyes or pigment of different colors or other fillers. Polymers useful in the articles of this invention are preferably thermoplastic polymers, e.g. polyolefins such as polyethylene and polypropylene, vinyl polymers such as polystyrene, styrene-acrylonitrile copolymers, styrene-butadiene copolymers and acrylonitrile-butadiene-styrene graft copolymers and polyvinyl butyral, polyamides such as nylon-6 or nylon-6,6, thermoplastic, urethane polymers, thermoplastic elastomers, and the like including blends and alloys of polymers. The polymers used in the molded articles can comprise a variety of additives, e.g. slip agents, stabilizers, UV absorbers and antioxidants. The polymers used in the molded articles can also comprise a variety of dispersed functional fillers, e.g. minerals such as silica, quartz and alumina, metal oxides such as titanium dioxide, iron oxide, indium tin oxide (ITO), antimony tin oxide (ATO), conductive fillers such as carbon black; carbon fibers, ITO, ATO or conductive polymers such as polyaniline or polypyrrole. Preferred polymeric material for many applications such as door mats is polyethylene with different color pigment additives for the specific polymer used in different parts of the article. For instance, and in one embodiment of the invention, with reference to FIGS. 1 and 2, preferred door mats can comprise polyethylene in one color pigment for the base section ribs 1 of a mat and the base section 2 of the blade-like projecting elements and polyethylene in a distinct color pigment for the terminal parts 3 of blade-like projecting elements. FIG. 2 also illustrates another specific embodiment of the multi-color mat according to this invention wherein a portion of the terminal parts 3 of blade-like projecting elements contain the same color pigment as base 2 and a portion of the terminal parts 3 of blade-like projecting elements contain a different color pigment from base section 2.

As will be discussed below, individual polymer injection ports of the polymer block can be customized to supply multi-color polymer to selected parts, or all, of the projecting elements allowing for creative aesthetic design of patterned articles, especially door mats and flooring materials. In some cases a minority of the elements can comprise multi-polymer or a majority or all of the elements can comprise a multi-polymer.

In the case of door mats it is generally preferred to laminate a slip-resistant sheet to the base section 2. In the case of nest pads is preferred to provide open spaces in the mat to facilitate cleaning.

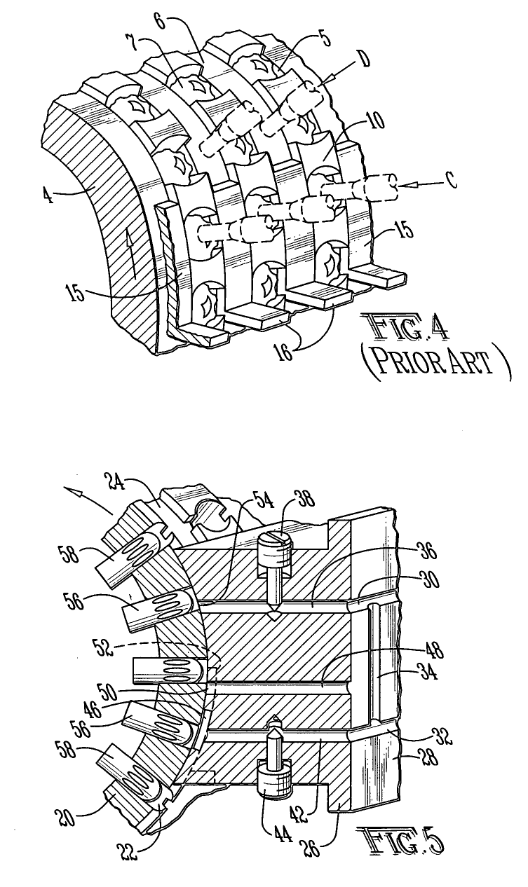

With reference to FIGS. 3 and 4 there is shown a sectional view of a continuous molding apparatus of the prior art which is used in the methods disclosed by Doleman et al. in U.S. Pat. 3,507,010, incorporated herein by reference. In that apparatus, mold drum 4 comprising rows of cavities 5 adjacent to ribbed base-forming spacer grooves 6. In cavity 5 is a plug 7 with blade-like shaping grooves 8. The mold drum rotates in proximity to a stationary polymer injection block 10. At the mold face there are a plurality of cavity injection ports 11 aligned to supply polymer through channels C to each of the corresponding rows of cavities 5 and a plurality of ribbed base-forming injection ports 12 aligned to supply polymer through channels D to corresponding groove 6 sections of the mold. The cavity injection ports 11 and supply channels C are offset from the ribbed base-forming injection ports 12 and supply channels D. In the illustrated prior art apparatus, and contrary to the present invention, the polymer for both sets of ports is supplied under pressure from a common source. Polymer flow control into the cavities is set by system pressure through channels C and into the ribbed base-forming grooves through channels D at a lower pressure by flow control means 14 which is preferably an adjustable control valve such as a throttling screw valve. A plurality of elongated wiper elements 15 are secured to the polymer injection block by tab 16 and slidingly fit into the grooves 6 to a distance at least beyond the cavity injection ports to assist in preventing polymer flow intended for the cavities to escape into the grooves.

With reference to FIG. 5, and in one embodiment of the invention, there is shown a rotatable mold drum 20 with a plurality of rows of cavities 22 and ribbed base-forming grooves 24 in the peripheral surface which is proximate to a matched arcuate surface of a stationary polymer injection block 26. The polymer injection block according to this invention has on its back face 28 a first polymer supply network comprising a first elongated groove 30, a second elongated groove 32 and a plurality of interconnecting grooves 34. Extending from first elongated groove 30 is a plurality of ribbed-base-forming channels 36 passing through flow control valve 38 and terminating at port 54 to supply said first polymer to the ribbed base-forming grooves 24 on a rotating mold drum 20. Extending from second elongated groove 32 is a plurality of cavity filling channels 42 passing through flow control valve 44 and terminating at slotted port 46 to supply said first polymer to the base section of projecting element forming cavity 22. Because cavities 22 are offset from grooves 24, channels 36 and 42 are correspondingly offset. Aligned with channel 42 is a second polymer supply channel 48, which communicates from the back face 28 to second polymer supply port 50, which serves to supply a second polymer to the cavities 22 for forming the terminal portions 58 of the projecting elements. The second polymer is supplied at greater pressure than the first polymer. Another alternative is to eliminate channel 34 and supply polymer to channels 30, 32 and 48 separately. Wiper elements 52 affixed to the stationary polymer injection block 26 and slidingly fitted into grooves 24 serve to contain the higher pressure second polymer in the area of the passing cavity 22. The back face 28 can be covered with a one or more gasketed backing plates (not shown) machined to supply a first polymer at one or more connections to the first polymer supply network and a second polymer at one or more connections to the second polymer channels 48. Valves 38 and 44 can be adjusted to supply the first polymer at different pressures to the ribbed base-forming ports 54 and the ports 46 which can be preferably slotted or not—simply an open bore. Accounting for system pressure drop in channels it is possible to design a first polymer supply network with only one or no valves. However, for maximum flexibility in choice of polymers, operating conditions and molded product design it is preferred to provide the stationary polymer injection block with both valves 38 and 44 on each of the corresponding channels 36 and 42, respectively.

The apparatus of this invention is used to produce a multi-polymer, three-dimensional, unitary, thermoplastic, molded article having projections extending from one side of a base 1 (shown in FIG. 1). In a preferred method of operating mold drum 20 is designed to produce extended lengths of grass-like sheet with blade-like elements extending from a ribbed base 1.

In the method for forming three-dimensional, multi-polymer articles, a first polymer is first supplied from a first set of two sets of circumferentially aligned, cavity injection ports to a cavity area in a mold drum 20 (shown in FIG. 5) rotating in arcuate proximity with the first set of ports to form in the cavities base section-proximate parts 2 of projecting elements. A different polymer is then supplied from a second set of said two sets of circumferentially aligned, cavity injection ports to said cavity area rotating past said first sets if port into proximity with said second set of ports to form in said cavities terminal parts of said projecting elements. The first polymer is supplied at a relatively low pressure so as to fill only the part of the cavity proximate solidifying at the mold wall and remaining generally molten in the core. The second polymer is supplied at a relatively high pressure to flow through the generally molten core to the terminal parts of the cavity. Some of the molten first polymer that is advanced toward the terminal end and the final projecting elements generally have a different polymer core with a first polymer surface at the base section 2 and a second polymer surface at the terminal ends 3. Accordingly, the cross-section of the base section 2 is large enough to provide art essentially solid mold wall and a generally molten polymer core. One skilled in the art may determine the dimensions of the cross-section of the base section 2 without undue experimentation depending on the specific polymers used. For example, the molten core may comprise one half of the total cross-section of the base section 2.

In making multi-color grass-like mats both a first and second polymer can comprise low density polyethylene (LDPE) with a density in the range of 0.915 to 0.92 (as determined by ASTM D-192). The polymer composition can be 99.2 parts LDPE and 0.2 parts of adjuvants including, for example, UV stabilizer, colorants, slip agent and antioxidant. The difference between the first and second polymer will be the coloring agent. Useful temperatures for processing molten LDPE are in the vicinity of 200° C. (about 400° F.), while maintaining a coolant circulating through the mold drum at about 20° C. The mold drum can rotate over a wide range of speeds, but typically in the range of about 0.5 to about 5 rpm. Polymer supply pressure will vary depending on system pressure drop and will be in the range of about 1000 to about 40,000 kPa. With cooling effected in the mold, a continuous, three-dimensional, unitary, molded, multi-polymer article can be extracted from the rotating mold. The continuous article can be cut into desired shapes with mechanical shears or guillotine blades. To provide a slip-resistant door mat it is useful to adhere a rubberized fabric sheet e.g. to molten polymer or by application of adhesive.

In the case of decorative multi-color door mats any of a wide variety of color schemes can be selected depending on aesthetic taste, e.g. white tipped blades on a black base, yellow tipped blades on a green base, tan tipped blades on a brown base, or even ivory tipped blades on a taupe base. Further enhancements in design can be achieved by varying the length of the plugs in the cavities in geometric patterns. For instance sculptured borders can be achieved by plugging cavities in a pattern. In other embodiments, backing plates can be drilled to supply the first polymer to selected channels D to provide certain projecting elements entirely in the same color pigment as the base. In still other cases, variation in colors or pigments among a group of buds or within a single bud of projecting elements can be achieved by plug design, e.g. vents for blade like elements can be of variable size so that low pressure injection of a first polymer can fully fill the blade mold for elements with larger diameter vents and only a higher pressure second polymer can fully fill the blade mold for elements with smaller diameter vents. Elements with intermediate vents may have more or less of the two polymers. Alternatively, plugs can be solid and located close to the surface to provide essentially no projections merely a base section for mat integrity, a concept which is useful in sculptured mats. Mold design can permit production of a multi-color mat with at least a minority of said blade-like projecting elements of a different color pigment from the base; or, alternatively, with at least a majority of such elements of a different color pigment from the base section 2.

As can be appreciated from the foregoing description of a polymer block supplying two polymers, it can be appreciated that a polymer block for supplying three or more polymers can be readily designed by supplementing the design as taught herein. For instance, said second set of cavity injection ports can comprise three or more injection ports for multiple polymer injection for forming projection elements comprising more than two polymer compositions. And, said first set of cavity injection ports can comprise two or more ports for multiple polymer injection for forming variable composition base elements. Accordingly, and in one embodiment of the present invention, the multi-color article of the present invention may also include a base section wherein at least some of the terminal parts of the projecting elements are formed from a distinct polymer material. The article may include more than two polymers. Such multiple ports can be arranged in alignment for uniformly injected elements or offset for variation in composition along the mold width. To provide variation in properties or aesthetic appearance.

For example, it is possible to apply multiple polymers to the base, e.g. with a tough and/or a sticky polymer applied to the rib cavities between base areas of projecting elements. Such tough rib elements can comprise high impact polystyrene or a blend of polyethylene with ethylene vinyl acetate or a blend of polyethylene and polyvinylbutyral.

The preceding description is set forth for purposes of illustration only and is not to be taken in a limited sense. Various modifications and alterations will be readily suggested to persons skilled in the art. It is intended, therefore, that the foregoing be considered as exemplary and that the scope of the invention as ascertained from the following claims.

What is claimed is:

1. A three-dimensional, unitary, molded, polymeric article comprising a generally planar two-dimensional base section formed from one polymer material and at least one projecting element extending from one side of said base section, wherein at least some terminal parts of said projecting elements are formed from a second polymer material.

2. The article according to claim 1 wherein said one polymeric material contains a first colored pigment and said second polymeric material contains a second colored pigment.

3. The article according to claim 2 wherein said base section contains a pigment that is different from said terminal parts of at least some of the projecting elements.

4. The article according to claim 2 wherein said base section and a portion of said terminal parts of at least some of said projecting elements contain the same pigment and a portion of said terminal parts of at least some of said projecting elements contain a different pigment than said base section.

5. The article according to claim 1 wherein said polymers are polymers selected from the group consisting of polyolefins, polyethylene, polypropylene, vinyl polymers, polystyrene, styrene-acrylonitrile copolymers, styrene-butadiene copolymers, acrylonitrile-butadiene-styrene graft copolymers, polyvinyl butyral, polyamides, nylon-6, nylon-6,6, thermoplastic, urethane polymers, thermoplastic elastomers, blends and alloys thereof.

6. The article according to claim 1 wherein said base section is formed from a first polymer material, said terminal parts of at least some of said projecting elements are formed from a second polymer material and said base section of said projecting elements having a first polymeric material at its surface and a second polymeric material at its core.

7. The article according to claim 1 further comprising at least one from the group consisting of dyes, pigments of distinct colors and other fillers.

8. The article according to claim 1 wherein at least one of said polymers is polyethylene.

9. The article according to claim 1 further comprising a slip-resistant sheet laminated to said base section.

10. The article according to claim 1 wherein said base section includes open spaces to facilitate cleaning.

11. The article according to claim 7 wherein said terminal parts of at least a minority of said projecting elements contain a different pigment than said base section.

12. The article according to claim 7 wherein said base section contains a distinct pigment.

13. The article according to claim 1 wherein at least one of said polymers comprises polyethylene with a density in the range of about 0.915 to about 0.92.

14. The article according to claim 1 further comprising at least one dispersed functional filler selected from the group consisting of minerals, alumina, metal oxides, conductive fillers and conductive polymers.

15. The article according to claim 1 wherein at least some terminal parts of said projecting elements are formed from at least one distinct polymer.

16. In a polymer molding apparatus for producing on a rotating cylindrical mold a length of continuous, three-dimensional, molded, polymeric article comprising a plurality of projecting elements extending from a base section, wherein said apparatus comprises:
(a) a rotatable, cylindrical mold having
(i) a plurality of circumferential, rows of cavities, and
(ii) a plurality of parallel grooves separating said rows of cavities; and
(b) a stationary polymer injection block in arcuate proximity to said mold and having
(i) a plurality of cavity injection ports for supplying polymer to corresponding rows of cavities to form said projecting elements, and
(ii) a plurality of base-forming injection ports for supplying polymer to corresponding parallel grooves to form said base section;
the improvement wherein said stationary polymer injection block comprises two sets of circumferentially aligned, cavity injection ports for supplying at least two different polymers to at least a portion of said cavities.

17. An apparatus according to claim 16 wherein
(a) a first set of said two sets of circumferentially aligned, cavity injection ports supplies a first polymer to a cavity area rotating into proximity with said first set of ports to form a base section-proximate part of said projecting elements, and
(b) a second set of said two sets circumferentially aligned, cavity injection ports supplies a second polymer to said cavity area rotating past said first port into proximity with said second set of ports to form a terminal part of said projecting elements.

18. An apparatus according to claim 16 wherein said first set of said two sets of circumferentially aligned, cavity injection ports and said surface injection ports communicate with a common supply of a first molten thermoplastic polymer.

19. An apparatus according to claim 16 wherein at least one of said two sets of circumferentially aligned, cavity injection ports and said surface injection ports further comprises a polymer flow control valve.

20. An apparatus according to claim 16 further comprising wiper elements affixed to said stationary polymer injection block and slidingly fitted into said grooves to contain a second polymer.

21. An apparatus according to claim 16 further comprising a back face in communication with said base section.

22. An apparatus according to claim 21 wherein said back face is covered with at least one gasketed backing plate machined to supply a first polymer at one or more connections to a first polymer supply network and a second polymer having at least one connection to a second polymer channel.

23. An apparatus according to claim 22 wherein said first polymer supply network has one valve.

24. An apparatus according to claim 16 wherein said first polymer supply network is void of valves.

25. An apparatus according to claim 16 wherein said stationary polymer injection block comprises two sets of circumferentially aligned, cavity injection ports or supply three or more distinct polymers to at least a portion of said cavities.

26. A method for forming a multi-polymer, three-dimensional article comprising:
supplying a polymer from a first set of two sets of circumferentially aligned, cavity injection ports to a cavity area in a mold drum rotating in arcuate proximity with said first set of ports to form in said cavities base section-proximate parts of projecting elements; and
supplying a different polymer from a second set of said two sets of circumferentially aligned, cavity injection ports to said cavity area rotating past said first set of ports into proximity with said second set of ports to form in said cavities terminal parts of said projecting elements.

27. The method according to claim 26 further comprising processing said polymers at a temperature of about 200 degrees Celsius while maintaining a coolant circulating through said mold drum at about 20 degrees Celsius.

28. The method according to claim 26 wherein said step of supplying said polymer to said cavity area in a mold drum comprises the step of supplying said polymer to said cavity area wherein said drum is rotating in the range of about 0.5 to about 5 rpm.

29. The method according to claim 26 further comprising the step of cutting said article into desired shapes.

30. The method according to claim 26 further comprising the step of adhering a rubberized fabric sheet to said article.

31. The method according to claim 26 wherein said step of supplying a different polymer from a second set of said two sets of circumferentially aligned, cavity injection ports to said cavity area comprises supplying said polymer at a relatively high pressure to flow through a molten core of said polymer to said terminal parts of said cavity and advancing said first molten polymer toward said terminal end and said projecting elements.

32. The method according to claim 26 wherein said step of supplying a first polymer comprises supplying said first polymer at a low pressure so as to fill only parts of said cavity solidifying at said mold wall and having a generally molten core.

33. The method of claim 26 wherein said step of supplying a polymer comprises supplying said polymer to a cavity area in a mold drum wherein said mold drum is designed to produce extended lengths of grass-like sheet with blade-like elements extending from a ribbed base.
